(19) United States
(12) Patent Application Publication
(10) Pub. No.: US 2014/0350991 A1
(43) Pub. Date: Nov. 27, 2014

(54) SYSTEMS AND METHODS FOR LOGISTICS NETWORK MANAGEMENT

(71) Applicant: Caterpillar Inc., Peoria, IL (US)

(72) Inventors: Thad Breton KERSH, Dunlap, IL (US); Anthony James GRICHNIK, Eureka, IL (US)

(73) Assignee: Caterpillar Inc., Peoria, IL (US)

(21) Appl. No.: 13/901,683

(22) Filed: May 24, 2013

(51) Int. Cl. G06Q 30/02; G06Q 10/06

(52) U.S. Cl. CPC G06Q 30/0202; G06Q 10/06315
USPC 705/7.25; 705/7.31

(57) ABSTRACT

A method for managing a logistics network is disclosed. The method may include receiving, by a processor, historical demand data representing historical demand for an item at each one of a plurality of facilities associated with the logistics network, the plurality of facilities including at least one manufacturing facility and at least one distributing facility; forecasting future demand data representing a forecasted future demand for the item at each one of the plurality of facilities based on the respective historical demand data and one or more respective business goals for each facility; adjusting the future demand data at each one of the facilities by compensating for a shipping time delay associated with shipping the item from a supplier to the facility; and combining the adjusted future demand data at each one of the facilities to generate combined future demand data representing demand for the item at the supplier.

### TECHNICAL FIELD

This disclosure relates generally to systems and methods for managing a logistics network, and more particularly, to systems and methods for managing a unified logistics network.

### BACKGROUND

Organizations often use a coordinated network of organizations, people, activities, information, and resources to move items from point to point. This network is often referred to as a logistics network. Entities involved in the logistics network typically include suppliers, manufacturers, logistic service centers, distribution centers, sales entities (e.g., wholesale, retail, etc.), end customers, and the like.

Logistics network management typically involves a plurality of interrelated sub-processes that manage and control virtually every aspect associated with production and delivery of a finished product to an end-user. The logistics network management may manage and control the acquisition and distribution of raw materials from the suppliers to the manufacturers, the manufacturing and production of the finished product by the manufacturers, the delivery, distribution, and storage of the finished product or other materials for a retailer or wholesaler, and the sale of the finished product to an end-user. An effective logistic management plan controls the flow and storage of inventory in the entities involved in the logistics network in order to meet customer needs and reduce overhead costs.

An exemplary system that may be used to manage a logistics network is disclosed in U.S. Pat. No. 7,860,598 to Fleischer et al. that issued on Dec. 28, 2010 (“the '598 patent”). Specifically, the system in the '598 patent controls material flow of a plurality of individual parts by attaching a transponder to each one of the individual parts. The individual parts may be supplied from a supplier to goods receipt sites such as a production warehouse, or to a spare part warehouse, or directly to end customers. The transponders store production and delivery data regarding the respective parts. When the individual parts are delivered to a goods receipt site, the data stored in the transponders are read and used for controlling further material flow.

Although the system of the '598 patent may be useful for tracking the flow of the individual parts among different goods receipt sites, the system of the '598 patent does not provide a way to allocate the individual parts between the goods receipt sites. For example, when the end customers request a certain quantity of individual parts, the system of the '598 patent cannot determine whether to ship the individual parts from the supplier, from the production warehouse, or from the spare part warehouse. In some cases, the system of the '598 patent may order the requested amount of individual parts from the supplier, while there may be some spare parts in the production warehouse. This may result in an inefficient allocation of resources.

The logistics network management system of the present disclosure is directed toward solving the problem set forth above and/or other problems of the prior art.

### SUMMARY

In one aspect, the present disclosure is directed to a computer-implemented method for managing a logistics network. The method may include receiving, by a processor, historical demand data representing historical demand for an item at each one of a plurality of facilities associated with the logistics network. The plurality of facilities may include at least one manufacturing facility and at least one distributing facility. The manufacturing facility manufactures products by using the item, and the distributing facility distributes the item for sale as a service or replacement part. The method may also include forecasting, by the processor, future demand data representing a forecasted future demand for the item at each one of the plurality of facilities based on the respective historical demand data and one or more respective business goals for each facility. The method may further include adjusting, by the processor, the future demand data at each one of the facilities by compensating for a shipping time delay associated with shipping the item from a supplier to the facility. Moreover, the method may include combining, by the processor, the adjusted future demand data at each one of the facilities to generate combined future demand data representing demand for the item at the supplier.

In another aspect, the present disclosure is directed to a logistics network management system that may include a processor and a memory module. The memory module may store instructions, that, when executed, enable the processor to receive historical demand data representing historical demand for an item at each one of a plurality of facilities associated with the logistics network. The plurality of facilities may include at least one manufacturing facility and at least one distributing facility. The manufacturing facility manufactures products by using the item, and the distributing facility distributes the item for sale as a service or replacement part. The processor may also be enabled to forecast future demand data representing a forecasted future demand for the item at each one of the plurality of facilities based on the respective historical demand data and one or more respective business goals for each facility. The processor may be further enabled to adjust the future demand data at each one of the facilities by compensating for a shipping time delay associated with shipping the item from a supplier to the facility. Still further, the processor may be enabled to combine the adjusted future demand data at each one of the facilities to generate combined future demand data representing demand for the item at the supplier.

In yet another aspect, the present disclosure is directed to a non-transitory computer-readable storage device. The storage device may store instructions for managing a logistics network. The instructions may cause one or more computer processors to perform operations including receiving historical demand data representing historical demand for an item at each one of a plurality of facilities associated with the logistics network. The plurality of facilities may include at least one manufacturing facility and at least one distributing facility. The manufacturing facility manufactures products by using the item, and the distributing facility distributes the item for sale as a service or replacement part. The operations may also include forecasting future demand data representing a forecasted future demand for the item at each one of the plurality of facilities based on the respective historical demand data and one or more respective business goals for each facility. The operations may further include adjusting the future demand data at each one of the facilities by compensating for a shipping time delay associated with shipping the item from a supplier to the facility. Still further, the operations may include combining the adjusted future demand data at each one of the facilities to generate combined future demand data representing demand for the item at the supplier.

### BRIEF DESCRIPTION OF THE DRAWINGS

FIG. 1 is a schematic illustration of an exemplary logistics network in which the logistics network management system consistent with the disclosed embodiments may be implemented.

FIG. 2 illustrates an exemplary logistics network management system that may be configured to perform certain functions consistent with disclosed embodiments.

FIG. 3 is a schematic illustration of another exemplary logistics network in which the logistics network management system consistent with disclosed embodiments may be implemented.

FIG. 4 is an exemplary graph showing a forecasted future demand at a first facility over a period of time.

FIG. 5 is an exemplary graph showing a forecasted future demand at a second facility over a period of time.

FIG. 6 is an exemplary graph showing an adjusted future demand at the first facility over a period of time.

FIG. 7 is an exemplary graph showing an adjusted future demand at the second facility over a period of time.

FIG. 8 is an exemplary graph showing a combined future demand at a supplier over a period of time.

FIG. 9 is a table summarizing different candidate allocation schemes generated as an exemplary embodiment.

FIG. 10 is a table summarizing different candidate transportation schemes generated as an exemplary embodiment.

FIGS. 11-14 are flow charts illustration exemplary processes for logistics network management, consistent with disclosed embodiments.

### DETAILED DESCRIPTION

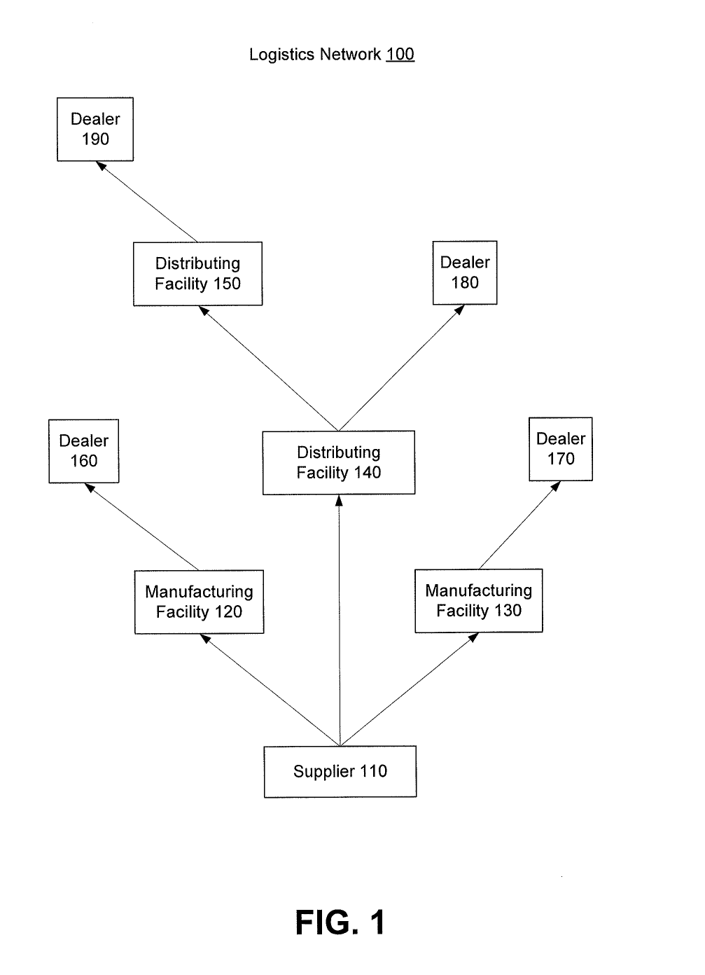

FIG. 1 illustrates an exemplary logistics network 100 in which the logistics network management system consistent with the disclosed embodiments may be implemented. As shown in FIG. 1, logistics network 100 may include a supplier 110, manufacturing facilities 120 and 130, distributing facilities 140 and 150, and dealers 160, 170, 180, and 190.

Supplier 110 may supply individual items to manufacturing facilities 120 and 130 and distributing facility 140. An item, as used herein, may represent any type of physical good that is designed, developed, manufactured, and/or delivered by supplier 110. Non-limiting examples of the items may include engines, tires, wheels, transmissions, pistons, rods, shafts, or any other suitable component of a product.

Manufacturing facilities 120 and 130 may manufacture or assemble products by using one or more individual items received from supplier 110. A product, as used herein, may represent any type of finished good that is manufactured or assembled by a manufacturing facility. Non-limiting examples of the products may include fixed or mobile machines such as trucks, cranes, earth moving vehicles, mining vehicles, backhoes, material handling equipment, farming equipment, marine vessels, on-highway vehicles, or any other type of movable machine that operates in a work environment. The products manufactured by manufacturing facility 120 and manufacturing facility 130 may be identical, or may be different from each other. Manufacturing facility 120 and manufacturing facility 130 may respectively deliver the manufactured products to dealers 160 and 170 for sale to end-customers (not shown).

Distributing facility 140 may store individual items received from supplier 110, and may distribute the individual items to dealer 180 for sale as service or replacement parts for existing products. For example, distributing facility 140 may store individual engines received from supplier 110. When distributing facility 140 receives a communication or other signal from dealer 180 indicating that the engine of a vehicle needs to be replaced, distributing facility 140 may deliver an engine to dealer 180. In addition, distributing facility 140 may distribute the individual items to distributing facility 150 which is physically separated from distributing facility 140. Distributing facility 150 may redistribute the individual items to dealer 190 for sale.

Although logistics network 100 shown in FIG. 1 includes one supplier 110, two manufacturing facilities 120 and 130, two distributing facilities 140 and 150, and four dealers 160, 170, 180, and 190, those skilled in the art will appreciate that logistics network 100 may include any number of suppliers, manufacturing facilities, distributing facilities, and dealers. For example, logistics network 100 may include more than one supplier to supply the same item. In another example, manufacturing facilities 120 and 130 may deliver manufactured products to the same dealer 160 or 170 for sale.

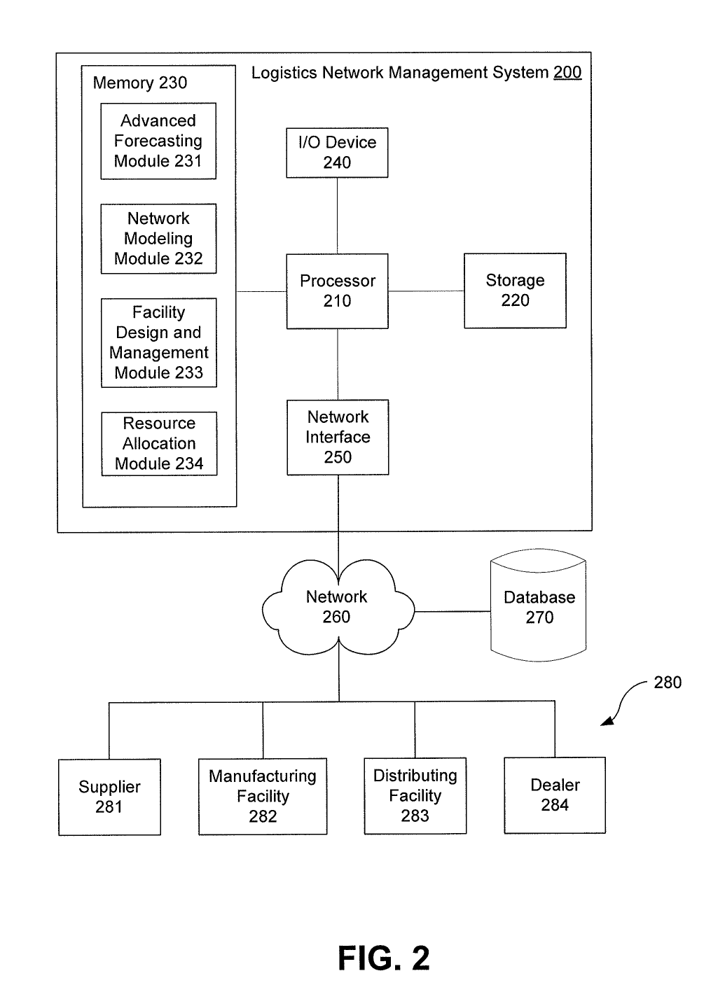

FIG. 2 illustrates an exemplary logistics network management system 200 (hereinafter referred to as “system 200”) consistent with certain disclosed embodiments. As shown in FIG. 2, system 200 may include one or more hardware and/or software components configured to display, collect, store, analyze, evaluate, distribute, report, process, record, and/or sort information related to logistics network management. System 200 may include one or more of a processor 210, a storage 220, a memory 230, an input/output (I/O) device 240, and a network interface 250. System 200 may be connected via network 260 to database 270 and logistics network 280, which may include one or more of a supplier 281, a manufacturing facility 282, a distributing facility 283, and a dealer 284. That is, system 200 may be connected to computers or databases stored at one or more of supplier 281, manufacturing facility 282, distributing facility 283, and dealer 284.

System 200 may be a server, client, mainframe, desktop, laptop, network computer, workstation, personal digital assistant (PDA), tablet PC, scanner, telephony device, pager, and the like. In one embodiment, system 200 may be a computer configured to receive and process information associated with different entities involved in logistics network 280, the information including purchase orders, inventory data, and the like. In addition, one or more constituent components of system 200 may be co-located with any one of supplier 281, manufacturing facility 282, and distributing facility 283.

Processor 210 may include one or more processing devices, such as one or more microprocessors from the Pentium™ or Xeon™ family manufactured by Intel™, the Turion™ family manufactured by AMD™, or any other type of processors. As shown in FIG. 2, processor 210 may be communicatively coupled to storage 220, memory 230, I/O device 240, and network interface 250. Processor 210 may be configured to execute computer program instructions to perform various processes and method consistent with certain disclosed embodiments. In one exemplary embodiment, computer program instructions may be loaded into memory 230 for execution by processor 210.

Storage 220 may include a volatile or non-volatile, magnetic, semiconductor, tape, optical, removable, nonremovable, or other type of storage device or computer-readable medium. Storage 220 may store programs and/or other information that may be used by system 200.

Memory 230 may include one or more storage devices configured to store information used by system 200 to perform certain functions related to the disclosed embodiments. In one embodiment, memory 230 may include one or more modules (e.g., collections of one or more programs or subprograms) loaded from storage 220 or elsewhere that perform (i.e., that when executed by processor 210, enable processor 210 to perform) various procedures, operations, or processes consistent with the disclosed embodiment. For example, memory 230 may include an advanced forecasting module 231, a network modeling module 232, a facility design and management module 233, and a resource allocation module 234.

Advanced forecasting module 231 may generate forecast information related to one or more target items at any one of supplier 281, manufacturing facility 282, distributing facility 283, and dealer 284, based on historical data associated with the target item. For example, advanced forecasting module 231 may forecast a future demand for an item at each one of manufacturing facility 282 and distributing facility 283 based on respective historical demand data for that item and respective business goal. The business goal may include at least one of profit, return on net assets, inventory turns, service level, and response time. In addition, advanced forecasting module 231 may forecast the future demand for the item at supplier 281 by combining the forecasted demand for the item at each one of manufacturing facility 282 and distributing facility 283.

Network modeling module 232 may receive the forecasted information from advanced forecasting module 231 and simulate and optimize the flow of materials (i.e., parts, products, etc.) between supplier 281, manufacturing facility 282, distributing facility 283, and dealer 284 in order to meet certain business goals of the entire organization that includes supplier 281, manufacturing facility 282, distributing facility 283, and dealer 284. The business goal may include at least one of profit, return on net assets, inventory turns, service level, and response time. Network modeling module 232 may simulate the flow of materials based on geographical locations of each one of supplier 281, manufacturing facility 282, distributing facility 283, and dealer 284, the transportation methods (e.g., air, ship, truck, etc.), and link capacities (e.g., quantity of items that can be transported via a certain route). Based on the simulation results and other information such as production costs, transportation costs, and regional sales price, and the like, network modeling module 232 may generate information such as gross revenue, cost of goods sold, and profit related to one or more products.

Facility design and management module 233 may receive the forecasted information from advanced forecasting module 231 and the simulation results from network modeling module 232 and may determine the physical structure and dimension of manufacturing facility 282 and/or distributing facility 283 based on the received information. For example, facility design and management module 233 may receive forecasted information representing quantity of the incoming items to be received at manufacturing facility 282 and/or distributing facility 283. Based on this forecasting information, facility design and management module 233 may determine dimensions, and locations of shelving, racks, aisles, and the like, of manufacturing facility 282 and/or distributing facility 283. Facility design and management module 233 may also determine the location of incoming items within manufacturing facility 282 and/or distributing facility 283, based on the forecasted information. Moreover, facility design and management module 233 may simulate the movement of resources (e.g., workers, machines, transportation vehicles, etc.) throughout manufacturing facility 282 and/or distributing facility 283 over time. Still further, facility design and management module 233 may modify input information in order to achieve one or more of the business goals associated with the entire organization.

Resource allocation module 234 may receive availability data representing the quantity of one or more items that are available at supplier 281. When the availability data is less than the forecasted demand data of the item at the suppliers, resource allocation module 234 may allocate the available items at manufacturing facility 282 and distributing facility 283 in order to achieve one or more of the business goals associated with the entire organization.

In some embodiments, the business goal associated with the entire organization is common across all of modules 231 through 234 of memory 230. That is, advanced forecasting module 231, network modeling module 232, facility design and management module 233, and resource allocation module 234 may perform their respective functions in order to achieve a common business goal, or a common business goal associated with the entire organization. For example, modules 231 through 234 may perform their respective functions in order to maximize profit of the entire organization.

I/O device 240 may include one or more components configured to communication information associated with system 200. For example, I/O device 240 may include a console with an integrated keyboard and mouse to allow a user to input parameters associated with system 200 and/or data associated with logistics network 280. I/O device 240 may include one or more displays or other peripheral devices, such as, for example, printers, cameras, microphones, speaker systems, electronic tablets, bar code readers, scanners, or any other suitable type of I/O device 240.

Network interface 250 may include one or more components configured to transmit and receive data via network 260, such as, for example, one or more modulators, demodulators, multiplexers, de-multiplexers, network communication devices, wireless devices, antennas, modems, and any other type of device configured to enable data communication via any suitable communication network. Network interface 250 may also be configured to provide remote connectivity between processor 210, storage 220, memory 230, I/O device 240, and/or database 270, to collect, analyze, and distribute data or information associated with logistics network 280 and logistics network management.

Network 260 may be any appropriate network allowing communication between or among one or more computing systems, such as, for example, the Internet, a local area network, a wide area network, a WiFi network, a workstation peer-to-peer network, a direct link network, a wireless network, or any other suitable communication network. Connection with network 260 may be wired, wireless, or any combination thereof.

Database 270 may be one or more software and/or hardware components that store, organize, sort, filter, and/or arrange data used by system 200 and/or processor 210. Database 270 may store one or more tables, lists, or other data structures containing data associated with logistics network management. For example, database 270 may store operational data associated with each one of supplier 281, manufacturing facility 282, distributing facility 283, and dealer 284, such as inbound and outbound orders, production schedules, production costs, and resources. The data stored in database 270 may be used by processor 210 to receive, categorize, prioritize, save, send, or otherwise manage data associated with logistics network management.

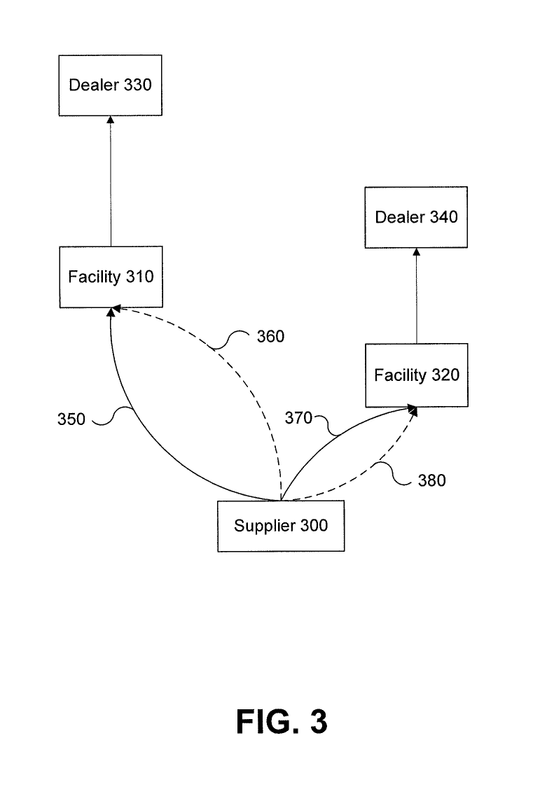

FIGS. 3-8 illustrate a method of logistics network management according to an exemplary embodiment. In particular, FIG. 3 illustrates an exemplary logistics network in which system 200 consistent with disclosed embodiments may be implemented. As shown in FIG. 3, supplier 300 may supply certain items to facility 310 and facility 320. For example, facility 310 may be a manufacturing facility, and facility 320 may be a distributing facility. Based on the geographical locations of supplier 300 and facilities 310 and 320 and/or transportation methods being used to ship different items, system 200 may assume that it may take two months to ship items from supplier 300 to facility 310, and that it may take one month to ship items from supplier 300 to facility 320.

First, advanced forecasting module 231 of system 200 may forecast the future demand for a certain item at each one of facilities 310 and 320 based on respective historical demand data and respective business goals at each one of facilities 310 and 320. Advanced forecasting module 231 may forecast the future demand for the item at facility 310 or 320 by using various methods. In a non-limiting exemplary embodiment, advanced forecasting module 231 may use a genetic algorithm to forecast the future demand. For example, advanced forecasting module 231 may first determine a forecast function representing the future demand for the item. The forecast function may include one or more variables. Next, advanced forecasting module 231 may generate one or more chromosomes (data sets) having a data value for each of the variables on the forecast function. Next, advanced forecasting module 231 may determine a chromosome value for each one of the chromosomes based on a goal function representing one or more business goals of facility 310 or 320. Then, advanced forecasting module 231 may select a chromosome from among the one or more chromosomes based on the chromosome values. Finally, advanced forecasting module 231 may forecast the future demand for the item by using the forecast function with the variables having data values in the selected chromosome.

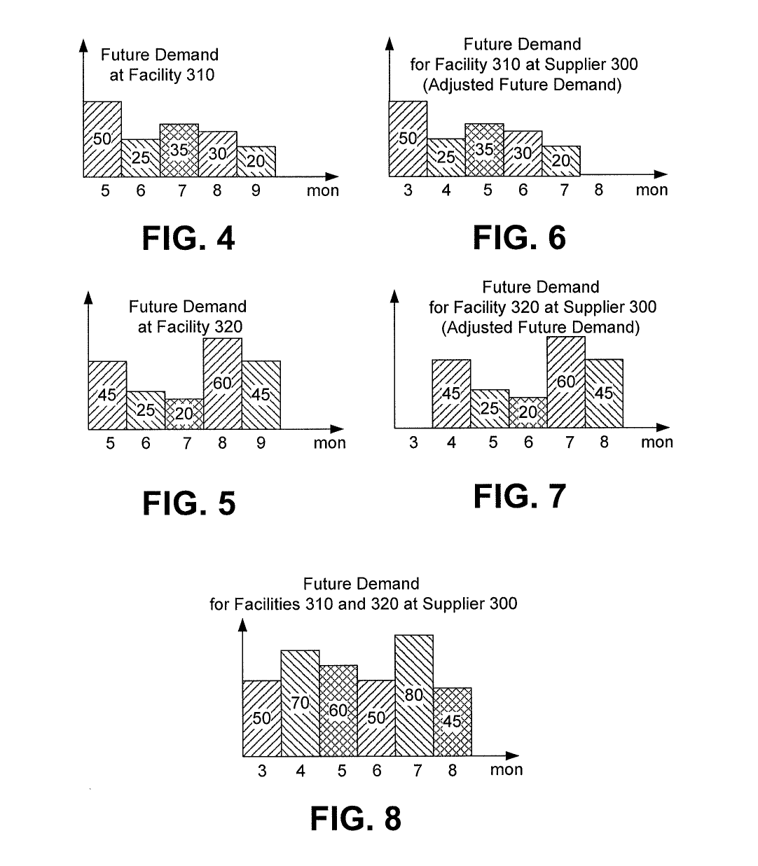

FIG. 4 is an exemplary graph showing the forecasted future demand for the item at facility 310 over a period of five months (month 5 through month 9). The X-axis and the Y-axis of FIG. 4 represent time (number of months from the time the forecasting is made) and quantity of the demanded items, respectively. As shown in FIG. 4, facility 310 may need 50 items, 25 items, 35 items, 30 items, and 20 items at month 5, month 6, month 7, month 8, and month 9, respectively.

FIG. 5 is an exemplary graph showing the forecasted future demand for the item at facility 320 over the period of five months (month 5 through month 9). As shown in FIG. 5, facility 320 may need 45 items, 25 items, 20 items, 60 items, and 45 items at month 5, month 6, month 7, month 8, and month 9, respectively.

Next, advanced forecasting module 231 may adjust the forecasted future demand for the item at each one of facilities 310 and 320 by compensating for a shipping time delay between supplier 300 and each one of facilities 310 and 320. Advanced forecasting module 231 may obtain the information regarding a shipping time delay from network modeling module 232. Alternatively, advanced forecasting module 231 may assume a certain transportation scheme for delivering items from supplier 300 to facilities 310 and 320, and may calculate a shipping time delay according to the transportation scheme. As will be explained later, the transportation scheme may be adjusted based on the allocation scheme determined by advanced forecasting module 231.

FIG. 6 is an exemplary graph showing the adjusted future demand for the item at facility 310. Accordingly to FIG. 6, in order to compensate for the shipping time delay of two months between supplier 300 and facility 310, the X-axis of FIG. 6 shifts by two months with respect to the X-axis of FIG. 4. The adjusted future demand represents the future demand for facility 310 at supplier 300. For example, according to FIG. 6, in order to fulfill the demand for 50 items at facility 310 in month 5, supplier 300 should begin to ship 50 items to facility 310 in month 3 in order to arrive at facility 310 in month 5.

FIG. 7 is an exemplary graph showing the adjusted future demand for the item at facility 320. Accordingly to FIG. 7, in order to compensate for the shipping time delay of one month between supplier 300 and facility 320, the X-axis of FIG. 7 shifts by one month with respect to the X-axis of FIG. 5. Similarly, the adjusted future demand represents the future demand for facility 320 at supplier 300. For example, according to FIG. 7, in order to fulfill the demand for 45 items at facility 320 in month 5, supplier 300 should begin to ship 45 items to facility 320 in month 4 in order to arrive at facility 320 in month 5.

Then, advanced forecasting module 231 may combine the adjusted future demand at each one of facilities 310 and 320 to generate a combined future demand for production of the item at supplier 300. The combined future demand represents the future demand for both of facility 310 and facility 320 at supplier 300, i.e., the future demand from the perspective of supplier 300. FIG. 8 is an exemplary graph showing the future demand for the item at supplier 300, which is generated by combining the adjusted future demand shown in FIG. 6 and the adjusted future demand shown in FIG. 7. For example, according to FIG. 8, in order to fulfill the demand for 25 items at facility 310 in month 6 and the demand for 45 items at facility 320 in month 5, there should be at least 70 items available at supplier 300 in month 4.

Based on the combined future demand at supplier 300, system 200 may generate purchase orders to be transmitted to supplier 300. In response to the purchase orders, supplier 300 may provide the items according to the purchase orders.

In some embodiments, supplier 300 may generate a signal including availability data representing a quantity of the items that are available at supplier 300, and may transmit the signal to system 200. System 200 may compare the availability data with the combined future demand data. When the availability data is greater than or equal to the combined future demand data, system 200 may instruct supplier 300 to deliver the available items to facilities 310 and 320 according to the adjusted future demand at facility 310 and facility 320, as shown in FIGS. 6 and 7 respectively. For example, when there are 70 items available at supplier 300 in month 4, supplier may begin to ship, in month 4, 25 items to facility 310, and 45 items to facility 320, so that facility 310's demand for 25 items in month 6 may be fulfilled, and facility 320's demand for 45 items in month 5 may be fulfilled.

In certain embodiments, network modeling module 232 of system 200 may determine a transportation scheme (shipping method and/or route) for delivering available items from supplier 300 to facilities 310 and 320. For example, network modeling module 232 may first generate a plurality of candidate transportation schemes, and then select a transportation scheme by taking into account a measure of one or more organizational business goals of the entire organization. The organization may include both of facilities 310 and 320, and dealers 330 and 340 for selling the products manufactured by facilities 310 and 320. The organizational business goal may be short-term profit, return on net assets, inventory turns, service level, or response time, or a combination thereof. For example, if the organization wishes to achieve a maximum short-term profit, network modeling module 232 may select a transportation scheme that costs the least among the plurality of candidate transportation schemes. For another example, if the organization wishes to achieve a maximum service level or minimum response time, network modeling module 232 may select a transportation scheme that is the fastest among the plurality of candidate transportation schemes.

In certain embodiments, network modeling module 232 may determine a transportation scheme before receiving the availability data from supplier 300, and, based on the determined transportation scheme, advanced forecasting module 231 may adjust the forecasting for the future demand. For example, network modeling module 232 may assume that supplier 300 would have enough supply, which is equal to the future demand forecasted by advanced forecasting module 231, to fulfill the orders from facilities 310 and 320. Based on the assumption, network modeling module 232 may generate a plurality of candidate transportation schemes, and then select a transportation scheme by taking into account one or more organizational business goals of the entire organization. Then, advanced forecasting module 231 may calculate an updated shipping time delay for each of facilities 310 and 320 based on the selected transportation scheme, and may adjust the forecasted future demand at each of facilities 310 and 320 based on the updated shipping time delay. Next, advanced forecasting module 231 may combine the forecasted future demand at each of facilities 310 and 320 that are adjusted based on the updated shipping time delay, to adjust the forecasted future demand at supplier 300. Thereafter, network modeling module 232 may adjust the transportation scheme based on the adjusted future demand at supplier 300. This way, the adjusting of the transportation scheme and the adjusting of the forecasted future demand may be performed iteratively, until both of the transportation scheme and the future demand are stabilized, i.e, when each one of them does not with respect to the change in the other one.

In certain embodiments, after both of the transportation scheme and the future demand are stabilized, facility design and management module 233 may determine physical dimensions of each of facilities 310 and 320 based on the transportation scheme and the future demand of each of facilities 310 and 320 to accommodate for incoming items that are distributed from supplier 300 based on the transportation scheme. Facility design and management module 233 may determine locations of the incoming items inside each of facilities 310 and 320. Alternatively, determining the physical dimensions and the location of the incoming items may be performed during the iteration of the adjusting of the forecasted future demand and the transportation scheme. This way, operational cost incurred by rearranging each of facilities 310 and 320 may be considered when determining a business goal value.

In certain embodiments, after receiving purchase orders for a certain item from system 200 supplier 300 may evaluate its production schedule, available resources and the like, and transmit a signal to system 200 indicating that it cannot fulfill the purchase orders. Supplier 300 may further transmit a signal including availability data of the item (quantity of the item that is available at supplier 300). Based on the availability data, system 200 may allocate the available items between facility 310 and facility 320.

Conventionally, system 200 may allocate the available items between facilities 310 and 320 according to a fixed rule. For example, system 200 may always allocate 70% of the available items to facility 310, and 30% of the available items to facility 320. However, the conventional allocation method using the fixed rule does not take into account the forecast error, or transportation limitations such as shipping delays, shipping capacity, and the like. Thus, the fixed rule needs to be constantly updated.

In some embodiments of the present disclosure, resource allocation module 234 may be configured to coordinate with network modeling module 232 to determine an allocation scheme for allocating the available items between facilities 310 and 320 and a transportation scheme for transporting the allocated items to facilities 310 and 320, by taking into account of one or more organizational business goals of the entire organization.

Below is an exemplary embodiment for determining the allocation scheme and the transportation scheme by taking into account the profit of the entire organization. The current embodiment may be implemented in the network illustrated in FIG. 3. Referring to FIG. 3, supplier 300 may distribute a plurality of available items to facilities 310 and 320, while the amount of available items is less than the combined forecasted demand for the items at facilities 310 and 320. Facility 310 may be a manufacturing facility that uses 4 items to manufacture one product, and delivers the manufactured product to dealer 330. Facility 320 may be a distributing facility which distributes individual items to dealer 340 for sale as a service or replacement part. Supplier 300 may supply items to facility 310 via either one of route 350 and route 360, and may supply items to facility 320 via either one of route 370 and route 380. In this example, it is assumed that there are a total of 30 available items at the supplier. It is also assumed that the transportation schemes and the shipping costs for transporting the manufactured product from facility 310 to dealer 330 and for transporting the items from facility 320 to dealer 340 are fixed.

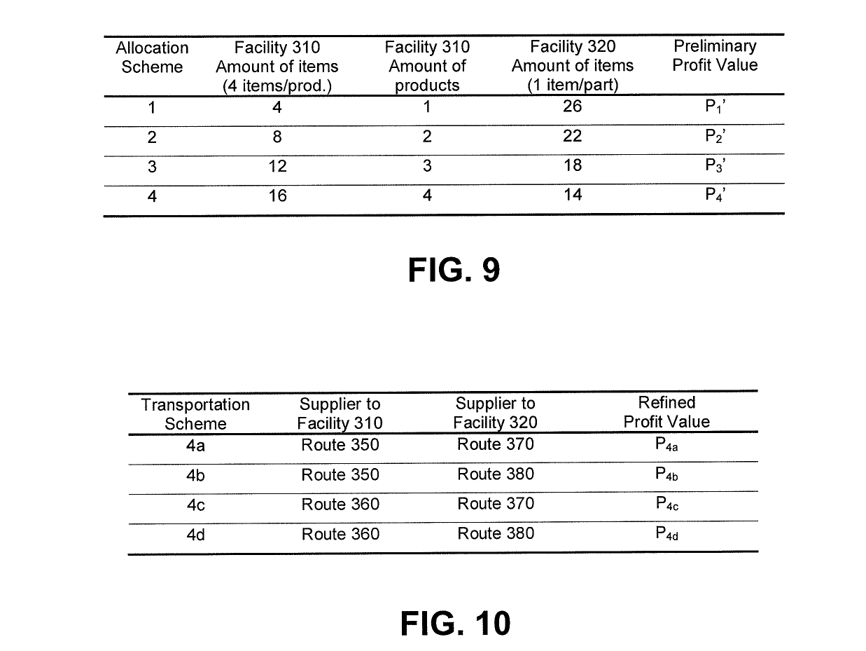

First, resource allocation module 234 may generate a plurality of candidate allocation schemes for allocating the available items between facilities 310 and 320. FIG. 9 is a table summarizing candidate allocation schemes 1 through 4, as an example. According to FIG. 9, in allocation scheme 1, facility 310 receives 4 items and manufactures one product using the 4 items, while facility 320 receives the remaining 26 items and delivers them for sale as 26 parts; in allocation scheme 2, facility 310 receives 8 items and manufactures 2 products using the 8 items, while facility 320 receives the remaining 22 items and delivers them for sale as 22 parts; in allocation scheme 3, facility 310 receives 12 items and manufactures 3 products using the 12 items, while facility 320 receives the remaining 18 items and delivers them for sale as 18 parts; in allocation scheme 4, facility 310 receives 16 items and manufactures 4 products using the 16 items, while facility 320 receives the remaining 14 items and delivers them for sale as 22 parts.

Resource allocation module 234 may calculate a preliminary profit value for each one of the candidate allocation schemes 1 through 4. For example, the preliminary profit values may be equal to a sum of the profit obtained by selling the manufactured products, plus a sum of the profit obtained by selling the service or replacement parts, minus the shipping cost for shipping the manufactured products from facility 310 to dealer 330, and the shipping cost for shipping the service or replacement parts from facility 320 to dealer 340. Specifically, the preliminary profit values may be represented by the following equations:

P₁′=1×p_{product}+26×pₚₐᵣₜ−(1×c₁+26×c₂)

P₂′=2×p_{product}+22×pₚₐᵣₜ−(2×c₁+22×c₂)

P₃′=3×p_{product}+18×pₚₐᵣₜ−(3×c₁+18×c₂)

P₄′=4×p_{product}+14×pₚₐᵣₜ−(4×c₁+14×c₂)

wherein Pₙ′ is the preliminary profit value produced by allocation scheme n, p_{product} is the profit for each product, pₚₐᵣₜ is the profit for the part, c₁ is the shipping cost for shipping a product from facility 310 to dealer 330, and c₂ is the shipping cost for shipping a part from facility 320 to dealer 340. Resource allocation module 234 may select an allocation scheme from the candidate allocation schemes 1 through 4 that produces a maximum preliminary profit value. In this example, it is assumed that allocation scheme 4 produces the maximum preliminary profit value.

Then, network modeling module 232 may generate a plurality of candidate transportation schemes for transporting the available items from supplier 300 to facilities 310 and 320, with the available items being allocated according to the selected allocation scheme 4. FIG. 10 is a table summarizing candidate transportation schemes 4a through 4d as an example. According to FIG. 10, in transportation scheme 4a, supplier 300 supplies items to facility 310 via route 350, and supplies items to facility 320 via route 370; in transportation scheme 4b, supplier 300 supplies items to facility 310 via route 350, and supplies items to facility 320 via route 380; in transportation scheme 4c, supplier 300 supplies items to facility 310 via route 360, and supplies items to facility 320 via route 370; in transportation scheme 4d, supplier 300 supplies items to facility 310 via route 360, and supplies items to facility 320 via route 380.

Network modeling module 232 may calculate a refined profit value for each one of the candidate transportation schemes 4a through 4d. As described previously, in this example, it is assumed that allocation scheme 4 produces the maximum preliminary profit value. According to allocation scheme 4, supplier 300 ships 16 items to facility 310, and ships 14 items to facility 320. For example, the refined profit values may be equal to the preliminary profit value minus the shipping cost for shipping the available items from supplier 300 to each one of facilities 310 and 320. Specifically, the refined profit values may be represented by the following equations:

P₄ₐ=P₄′−(16×c₃₅₀+14×c₃₇₀)

P_{4b}=P₄′−(16×c₃₅₀+14×c₃₈₀)

P_{4c}=P₄′−(16×c₃₆₀+14×c₃₇₀)

P_{4d}=P₄′−(16×c₃₆₀+14×c₃₈₀)

wherein P₄ₐ, P_{4b}, P_{4c}, and P_{4d} are the refined profit value produced by allocation scheme 4 and transportation schemes 4a, 4b, 4c, and 4d, respectively, c₃₅₀ is the shipping cost for shipping an item from supplier 300 to facility 310 via route 350, c₃₆₀ is the shipping cost for shipping an item from supplier 300 to facility 310 via route 360, c₃₇₀ is the shipping cost for shipping an item from supplier 300 to facility 320 via route 370, and c₃₈₀ is the shipping cost for shipping an item from supplier 300 to facility 320 via route 380.

Network modeling module 232 may select a transportation scheme from the candidate transportation schemes 4a through 4d that produces a maximum refined profit value. In this example, it is assumed that transportation scheme 4a produces the maximum refined profit value.

Finally, system 200 may send instructions to supplier 300 to distribute the available items based on the allocation scheme selected by resource allocation module 234 and the transportation scheme selected by network modeling module 232. In this example, system 200 may send instructions to supplier 300 to distribute the available items based on allocation scheme 4 and transportation scheme 4a.

Facility design and management module 233 may further determine physical dimensions of each of facilities 310 and 320 to accommodate for incoming items that are distributed from supplier 300 based on the allocation scheme and the transportation scheme. Facility design and management module 233 may also determine location of the incoming items inside each of facilities 310 and 320.

Although in the embodiments described above, the logistics network shown in FIG. 3 includes only one manufacturing facility 310 and one distributing facility 320, those skilled in the art will appreciate that the logistics network may include any number of manufacturing facilities and distributing facilities. In addition, when the logistics network includes more than one manufacturing facility, the manufacturing facilities may manufacture different types of products using different numbers of items received from supplier 300. For example, a first manufacturing facility may manufacture a first product by using four items received from supplier 300, while a second manufacturing facility may manufacture a second product by using six items received from supplier 300. Moreover, although in the logistics network shown in FIG. 3 the transportation schemes from facilities 310 and 320 to respective dealers 330 and 340 are fixed, those skilled in the art will appreciate that the transportation schemes may also be varied in view of different transportation methods or routes.

### INDUSTRIAL APPLICABILITY

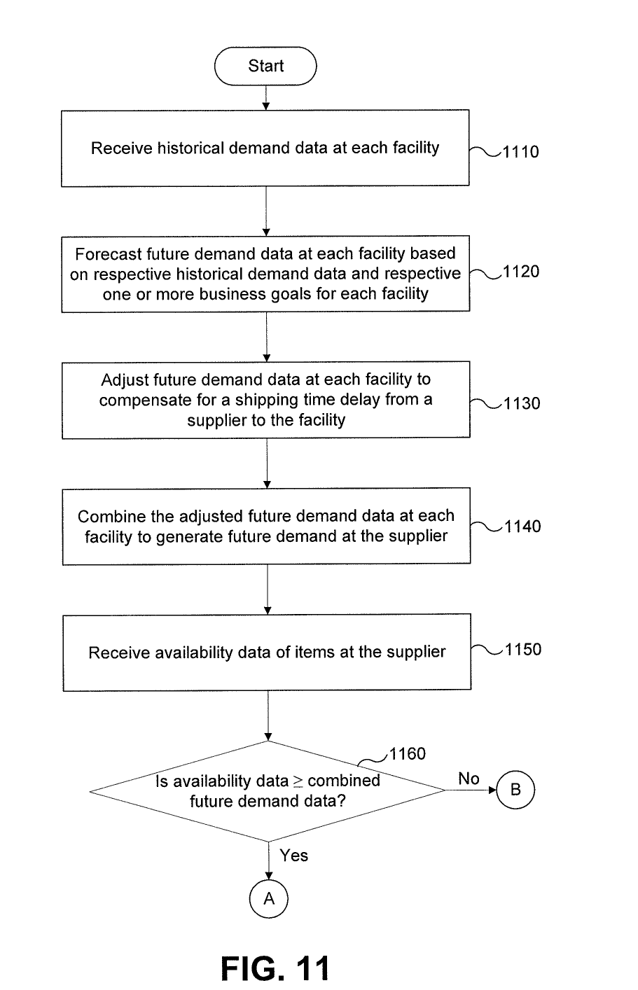

The disclosed logistics network management system 200 may be applicable to any logistics network where efficient logistic management is desired. The operation of logistics network management system 200 will now be described in connection with the flowcharts of FIGS. 11-14.

Referring to FIG. 11, system 200 may first receive historical demand data for an item at each of facilities 310 and 320 (step 1110). Then, system 200 may forecast future demand data at each of facilities 310 and 320 based on the respective historical demand data and respective one or more business goals for each of facilities 310 and 320 (step 1120). For example, system 200 may forecast the future demand data at facility 310 based on the historical demand data at facility 310 and the business goals of facility 310, and may forecast the future demand data at facility 320 based on the historical demand data at facility 320 and the business goals of facility 320.

System 200 may adjust the future demand data at each of facilities 310 and 320 to compensate for a shipping time delay from supplier 300 to facility 310 or 320 (step 1130). For example, system 200 may adjust the future demand data at facility 310 to compensate for the shipping time delay from supplier 300 and facility 310, and may adjust the future demand data at facility 320 to compensate for the shipping time delay from supplier 300 and facility 320. Then, system 200 may combine the adjusted future demand data at each of facilities 310 and 320 to generate future demand data at supplier 300 (step 1140). For example, system 200 may combine the adjusted future demand data at facility 310 and the adjusted future demand data at facility 320 to generate the future demand data at supplier 300.

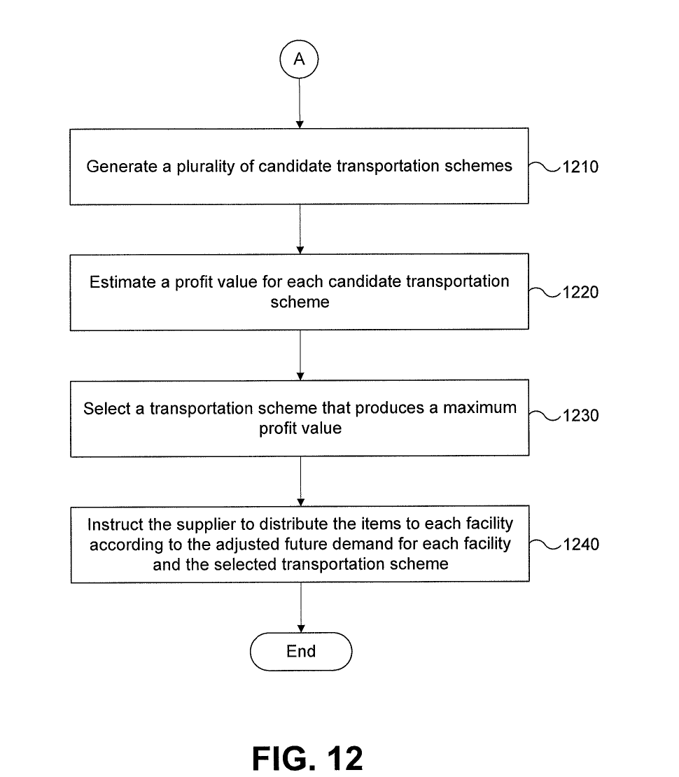

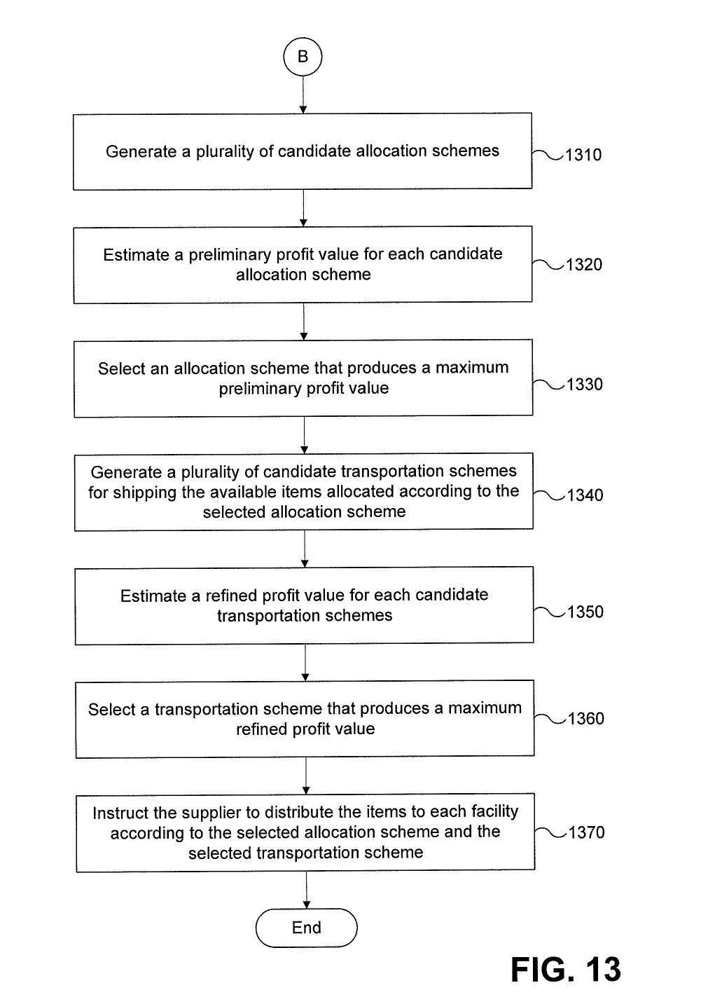

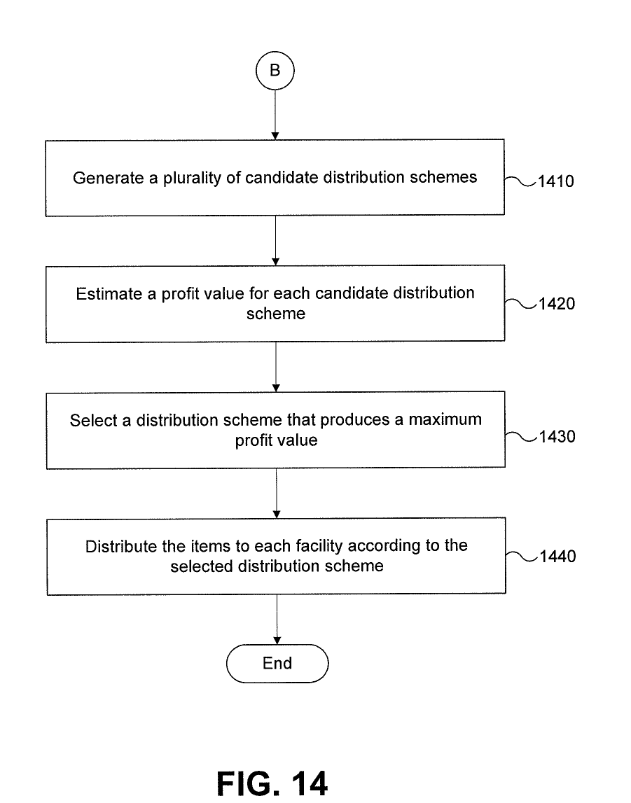

System 200 may receive availability data of the item at supplier 300 (step 1150). The availability data may represent a quantity of the item that is available at supplier 300. System may compare the availability data with the combined future demand data (step 1160). When the availability data is larger than or equal to the combined future demand data, process A described in FIG. 12 may be performed. When the availability data is less than the combined future demand data, process B described in FIG. 13, and described for an alternative embodiment in FIG. 14, may be performed.

Referring to FIG. 12, when the availability data is larger than or equal to the combined future demand data, system 200 may generate a plurality of candidate transportation schemes (step 1210). For example, system 200 may generate the candidate transportation schemes 1 through 4 summarized in the table of FIG. 10. System 200 may estimate a profit value for each one of candidate transportation schemes 1 through 4 (step 1220). For example, system 200 may estimate the profit value based on the shipping cost for shipping the available items from supplier 300 to each one of facilities 310 and 320, and the shipping cost for shipping manufactured products or service or replacement parts from each one of facilities 310 and 320 to their respective dealers 330 and 340.

System 200 may select a transportation scheme that produces a maximum profit value (step 1230). Finally, system 200 may instruct supplier 300 to distribute the available items to each one of facilities 310 and 320 according to the adjusted future demand for one of facilities 310 and 320 and the selected transportation scheme (step 1240).

In some embodiments, after system 200 selects the transportations scheme, system 200 may calculate a shipping time delay from shipping the available items from supplier 300 to each one of facilities 310 and 320 according to the selected transportation scheme. Then, the process may return to step 1130 where system 200 may re-adjust the further demand data at each one of facilities 310 and 320 to compensate for the calculated shipping time delay. Next, system 200 may combine the re-adjusted future demand data at each one of facilities 310 and 320 to generate the adjusted future demand data at supplier 300.

Referring to FIG. 13, when the availability data is less than the combined future demand data, system 200 may generate a plurality of candidate allocation schemes (step 1310). For example, system 200 may generate the candidate allocation schemes 1 through 4 summarized in the table of FIG. 9. System 200 may estimate a preliminary profit value for each one of the candidate allocation schemes 1 through 4 (step 1320). For example, system 200 may estimate the preliminary profit value by considering the shipping cost for shipping manufactured products or service or replacement parts from each one of facilities 310 and 320 to their respective dealers 330 and 340.

System 200 may select an allocation scheme that produces a maximum preliminary profit value (step 1330). System 200 may generate a plurality of candidate transportation schemes for shipping the available items allocated according to the selected allocation scheme (step 1340). For example, system 200 may generate the candidate transportation schemes 1 through 4 summarized in the table of FIG. 10. System 200 may estimate a refined profit value for each one of the candidate transportation schemes 1 through 4 (step 1350). For example, system 200 may estimate the refined profit value by considering the shipping cost for shipping the allocated items from supplier 300 to each one of facilities 310 and 320, and the shipping cost for shipping the manufactured products or service or replacement parts from each one of facilities 310 and 320 to their respective dealers 330 and 340.

System 200 may select a transportation scheme that produces a maximum refined profit value (step 1360). Finally, system 200 may instruct supplier 300 to distribute the available items to each one of facilities 310 and 320 according to the selected allocation scheme and the selected transportation scheme (step 1370).

In some embodiments, instead of determining the allocation scheme and transportation scheme separately, system 200 may determine a distribution scheme that includes an allocation scheme and a transportation scheme. FIG. 14 is a flow chart illustrating such method. According to FIG. 14, system 200 may first generate a plurality of candidate distribution schemes (step 1410). Each candidate distribution scheme may include an allocation scheme describing how the available items at supplier 300 are allocated between facilities 310 and 320, and a transportation scheme describing how the available items are shipped from supplier 300 to each one of facilities 310 and 320.

Then, system 200 may calculate a profit value for each of the candidate distribution scheme (step 1420). The profit values may be equal to a sum of the profit obtained by selling the manufactured products, plus a sum of the profit obtained by selling the service or replacement parts, minus the shipping cost for shipping the available items from supplier 300 to each one of facilities 310 and 320, the shipping cost for shipping the manufactured products from facility 310 to dealer 330, and the shipping cost for shipping the service or replacement parts from facility 320 to dealer 340.

Next, system 200 may select a distribution scheme that produces a maximum profit value (step 1430). Finally, system 200 may instruct supplier 300 to distribute the available items to each one of facilities 310 and 320 according to the selected distribution scheme (step 1440).

According to the above embodiments, the disclosed logistics network management system may forecast a future demand at a supplier, by considering the business goal of each one of the facilities in the logistics network, and the shipping time delay between the supplier and each one of the facilities. Therefore, the disclosed logistics network management system may provide more accurate forecast data.

In addition, the disclosed logistics network management system may determine an allocation scheme for allocating limited resources (e.g., items) provided by the supplier to the facilities in the logistics network, and a transportation scheme for transporting the limited resource from the supplier to the facilities, by considering one or more business goals of the entire organization. When the business goal of the entire organization is profit or service level, the system may determine an allocation scheme and a transportation scheme that can maximize the business goal. When the business goal of the entire organization is response time, the system may determine an allocation scheme and a transportation scheme that can minimize the business goal. Therefore, a desired business goal may be achieved.

It will be apparent to those skilled in the art that various modifications and variations can be made to the disclosed logistics network management system. Other embodiments will be apparent to those skilled in the art from consideration of the specification and practice of the disclosed logistics network management system. It is intended that the specification and examples be considered as exemplary only, with a true scope being indicated by the following claims and their equivalents.

What is claimed is:

1. A computer-implemented method for managing a logistics network, the method comprising:
receiving, by a processor, historical demand data representing historical demand for an item at each one of a plurality of facilities associated with the logistics network, wherein the plurality of facilities include at least one manufacturing facility and at least one distributing facility, the manufacturing facility manufactures products by using the item, and the distributing facility distributes the item for sale as a service or replacement part;
forecasting, by the processor, future demand data representing a forecasted future demand for the item at each one of the plurality of facilities based on the respective historical demand data and one or more respective business goals for each facility;
adjusting, by the processor, the future demand data at each one of the facilities by compensating for a shipping time delay associated with shipping the item from a supplier to the facility; and
combining, by the processor, the adjusted future demand data at each one of the facilities to generate combined future demand data representing demand for the item at the supplier.

2. The method of claim 1, further including:
receiving, at the processor, availability data representing a quantity of the item that is available at the supplier;
comparing the availability data with the combined future demand data of the item at the supplier; and
generating a plurality of candidate transportation schemes for transporting available items from the supplier to the facility when the availability data is greater than or equal to the combined future demand data;
estimating a business goal value associated with each one of the candidate transportation schemes based on costs of transporting the available items from the supplier to the facility;
selecting a transportation scheme that produces a desired business goal value; and
generating instructions to distribute the available items from the supplier to each one of the facilities according to the adjusted future demand data at each one of the facilities and according to the selected transportation scheme.

3. The method of claim 2, wherein the business goal value is associated with one or more organizational business goals including at least one of profit, return on net assets, inventory turns, response time, and service level.

4. The method of claim 1, further including:
receiving, at the processor, availability data representing a quantity of the item that is available at the supplier;
comparing the availability data with the combined future demand data of the item at the supplier;
generating a plurality of candidate allocation schemes for allocating the available items among the plurality of facilities when the availability data is less than the combined future demand data;
estimating a preliminary business goal value associated with each one of the candidate allocation schemes based on costs of transporting manufactured products or service or replacement parts from each of the plurality of facilities to dealers selling the manufactured products or the service or replacement parts;
selecting an allocation scheme that produces a desired preliminary business goal value from among the candidate allocation schemes;
generating a plurality of candidate transportation schemes for transporting the available items from the supplier to the facilities according to the selected allocation scheme;
estimating a refined business goal value associated with each one of the candidate transportation schemes and the selected allocation scheme based on the costs of transporting manufactured products or service or replacement parts from each of the plurality of facilities to the dealers and costs of transporting the available items from the supplier to each of the plurality of facilities;
selecting a transportation scheme that produces a desired refined business goal value from among the candidate transportation schemes; and
generating instructions to distribute the available items from the supplier to each one of the facilities according to the selected allocation scheme and the selected transportation scheme.

5. The method of claim 4, wherein the preliminary business goal value and the refined business goal value are associated with one or more organizational business goals including at least one of profit, return on net assets, inventory turns, response time, and service level.

6. The method of claim 4, further including:
determining physical dimensions of each one of the plurality of facilities to accommodate for incoming items that are distributed from the supplier based on the selected allocation scheme and the selected transportation scheme; and
determining location of the incoming items inside each one of the plurality of facilities.

7. The method of claim 1, wherein the forecasting future demand data of the item at each one of the plurality of facilities is performed by using a genetic algorithm.

8. The method of claim 1, further including estimating the shipping time delay based on historical transportation data.

9. The method of claim 1, further including:
receiving, at the processor, availability data representing a quantity of the item that is available at the supplier;
comparing the availability data with the combined future demand data of the item at the supplier; and
generating a plurality of candidate distribution schemes when the availability data is less than the combined future demand data, each candidate distribution scheme including a candidate allocation scheme for allocating the available items among the plurality of facilities and a candidate transportation scheme for transporting the available items from the supplier to each of the plurality of facilities;
estimating a business goal value associated with each one of the candidate distribution schemes based on costs of transporting the available items from the supplier to each of the plurality of facilities and costs of transporting manufactured products or service or replacement parts from each of the plurality of facilities to dealers selling the manufactured products or the service or replacement parts;
selecting a distribution scheme that produces a desired business goal value; and
generating instructions to distribute the available items from the supplier to each of the plurality of facilities according to the selected distribution scheme.

10. The method of claim 1, further including:
generating a plurality of candidate transportation schemes for transporting the item from the supplier to the facility, wherein a quantity of the item is equal to the combined future demand data;
estimating a business goal value associated with each one of the candidate transportation schemes based on costs of transporting the available items from the supplier to each of the plurality of facilities and costs of transporting manufactured products or service or replacement parts from each of the plurality of facilities to dealers selling the manufactured products or the service or replacement parts;
selecting a transportation scheme that produces a desired business goal value; and
calculating an updated shipping time delay associated with shipping the item from the supplier to the facility according to the selected transportation scheme;
re-adjusting the future demand data at each one of the facilities by compensating for the updated shipping time delay; and
combining the re-adjusted future demand data at each one of the facilities to generated an updated future demand data at the supplier.

11. A logistics network management system, comprising:
a processor; and
a memory module configured to store instructions, that, when executed, enable the processor to:
receive historical demand data representing historical demand for an item at each one of a plurality of facilities associated with the logistics network, wherein the plurality of facilities include at least one manufacturing facility and at least one distributing facility, the manufacturing facility manufactures products by using the item, and the distributing facility distributes the item for sale as a service or replacement part;
forecast future demand data representing a forecasted future demand for the item at each one of the plurality of facilities based on the respective historical demand data and one or more respective business goals for each facility;
adjust the future demand data at each one of the facilities by compensating for a shipping time delay associated with shipping the item from a supplier to the facility; and
combine the adjusted future demand data at each one of the facilities to generate combined future demand data representing demand for the item at the supplier.

12. The system of claim 11, the instructions stored in the memory module further enabling the processor to:
receive availability data representing a quantity of the item that is available at the supplier;
compare the availability data with the combined future demand data of the item at the supplier; and
when the availability data is greater than or equal to the combined future demand data, generate a plurality of candidate transportation schemes for transporting available items from the supplier to each one of the plurality of facilities;
estimate a business goal value associated with each one of the candidate transportation schemes based on costs of transporting the available items from the supplier to the facility;
select a transportation scheme that produces a desired business goal value; and
generate instructions to distribute the available items from the supplier to each one of the facilities according to the adjusted future demand data at each one of the facilities and according to the selected transportation scheme.

13. The system of claim 11, the instructions stored in the memory module further enabling the processor to:
receive availability data representing a quantity of the item that is available at the supplier;
compare the availability data with the combined future demand data of the item at the supplier; and
when the availability data is less than the combined future demand data, generate a plurality of candidate allocation schemes for allocating the available items among the plurality of facilities;
estimate a preliminary business goal value associated with each one of the candidate allocation schemes based on costs of transporting manufactured products or service or replacement parts from each of the plurality of facilities to dealers selling the manufactured products or the service or replacement parts;
select an allocation scheme that produces a desired preliminary business goal value from among the candidate allocation schemes;
generate a plurality of candidate transportation schemes for transporting the available items from the supplier to the facilities according to the selected allocation scheme;
estimate a refined business goal value associated with each one of the candidate transportation schemes and the selected allocation scheme based on the costs of transporting manufactured products or service or replacement parts from each of the plurality of facilities to the dealers and costs of transporting the available items from the supplier to each of the plurality of facilities;
select a transportation scheme that produces a desired refined business goal value from among the candidate transportation schemes; and
generate instructions to distribute the available items from the supplier to each one of the facilities according to the selected allocation scheme and the selected transportation scheme.

14. The system of claim 11, the instructions stored in the memory module further enabling the processor to:
receive availability data representing a quantity of the item that is available at the supplier;
compare the availability data with the combined future demand data of the item at the supplier; and
when the availability data is less than the combined future demand data, generate a plurality of candidate distribution schemes, each candidate distribution scheme including a candidate allocation scheme for allocating the available items among the plurality of facilities and a candidate transportation scheme for transporting the available items from the supplier to the facility;
estimate a business goal value associated with each one of the candidate distribution schemes based on costs of transporting the available items from the supplier to each of the plurality of facilities and costs of transporting manufactured products or service or replacement parts from each of the plurality of facilities to dealers selling the manufactured products or the service or replacement parts;
select a distribution scheme that produces a desired business goal value; and
generate instructions to distribute the available items from the supplier to each one of the facilities according to the selected distribution scheme.

15. The system of claim 11, the instructions stored in the memory module further enabling the processor to:
generate a plurality of candidate transportation schemes for transporting the item from the supplier to the facility, wherein a quantity of the item is equal to the combined future demand data;
estimate a business goal value associated with each one of the candidate transportation schemes based on costs of transporting the available items from the supplier to each of the plurality of facilities and costs of transporting manufactured products or service or replacement parts from each of the plurality of facilities to dealers selling the manufactured products or the service or replacement parts;
select a transportation scheme that produces a desired business goal value; and
calculate an updated shipping time delay associated with shipping the item from the supplier to the facility according to the selected transportation scheme;
re-adjust the future demand data at each one of the facilities by compensating for the updated shipping time delay; and
combine the re-adjusted future demand data at each one of the facilities to generated an updated future demand data at the supplier.

16. A non-transitory computer-readable storage device storing instructions for managing a logistics network, the instructions causing one or more computer processors to perform operations comprising:
receiving historical demand data representing historical demand for an item at each one of a plurality of facilities associated with the logistics network, wherein the plurality of facilities include at least one manufacturing facility and at least one distributing facility, the manufacturing facility manufactures products by using the item, and the distributing facility distributes the item for sale as a service or replacement part;
forecasting future demand data representing a forecasted future demand for the item at each one of the plurality of facilities based on the respective historical demand data and one or more respective business goals for each facility;
adjusting the future demand data at each one of the facilities by compensating for a shipping time delay associated with shipping the item from a supplier to the facility; and
combining the adjusted future demand data at each one of the facilities to generate combined future demand data representing demand for the item at the supplier.

17. The computer-readable storage device of claim 16, the instructions further causing the one or more computer processors to perform operations including:
receiving availability data representing a quantity of the item that is available at the supplier;
comparing the availability data with the combined future demand data of the item at the supplier; and
when the availability data is greater than or equal to the combined future demand data, generating a plurality of candidate transportation schemes for transporting available items from the supplier to the facility;
estimating a business goal value associated with each one of the candidate transportation schemes based on costs of transporting the available items from the supplier to each one of the plurality of facilities;
selecting a transportation scheme that produces a desired business goal value; and
generating instructions to distribute the available items from the supplier to each one of the facilities according to the adjusted future demand data at each one of the facilities and the selected transportation scheme.

18. The computer-readable storage device of claim 16, the instructions further causing the one or more computer processors to perform operations including:
receiving availability data representing a quantity of the item that is available at the supplier;
comparing the availability data with the combined future demand data of the item at the supplier; and
when the availability data is less than the combined future demand data, generating a plurality of candidate allocation schemes for allocating the available items among the plurality of facilities;
estimating a preliminary business goal value associated with each one of the candidate allocation schemes based on costs of transporting manufactured products or service or replacement parts from each one of the plurality of facilities to dealers selling the manufactured products or the service or replacement parts;
selecting an allocation scheme that produces a desired preliminary business goal value from among the candidate allocation schemes;
generating a plurality of candidate transportation schemes for transporting the available items from the supplier to the facilities according to the selected allocation scheme;
estimate a refined business goal value associated with each one of the candidate transportation schemes and the selected allocation scheme based on the costs of transporting manufactured products or service or replacement parts from each one of the plurality of facilities to the dealers and costs of transporting the available items from the supplier to each one of the plurality of facilities;
selecting a transportation scheme that produces a desired refined business goal value from among the candidate transportation schemes; and
generating instructions to distribute the available items from the supplier to each one of the facilities according to the selected allocation scheme and the selected transportation scheme.

19. The computer-readable storage device of claim 16, the instructions further causing the one or more computer processors to perform operations including:
receiving availability data representing a quantity of the item that is available at the supplier;
comparing the availability data with the combined future demand data of the item at the supplier; and
when the availability data is less than the combined future demand data, generating a plurality of candidate distribution schemes, each candidate distribution scheme including a candidate allocation scheme for allocating the available items among the plurality of facilities and a candidate transportation scheme for transporting the available items from the supplier to the facility;
estimating a business goal value associated with each one of the candidate distribution schemes based on costs of transporting the available items from the supplier to each one of the plurality of facilities and costs of transporting manufactured products or service or replacement parts from each one of the plurality of facilities to dealers selling the manufactured products or the service or replacement parts;
selecting a distribution scheme that produces a desired business goal value; and
generating instructions to distribute the available items from the supplier to each one of the facilities according to the selected distribution scheme.

20. The computer-readable storage device of claim 16, the instructions further causing the one or more computer processors to perform operations including:
generating a plurality of candidate transportation schemes for transporting the item from the supplier to the facility, wherein a quantity of the item is equal to the combined future demand data;
estimating a business goal value associated with each one of the candidate transportation schemes based on costs of transporting the available items from the supplier to each of the plurality of facilities and costs of transporting manufactured products or service or replacement parts from each of the plurality of facilities to dealers selling the manufactured products or the service or replacement parts;
selecting a transportation scheme that produces a desired business goal value; and
calculating an updated shipping time delay associated with shipping the item from the supplier to the facility according to the selected transportation scheme;
re-adjusting the future demand data at each one of the facilities by compensating for the updated shipping time delay; and
combining the re-adjusted future demand data at each one of the facilities to generated an updated future demand data at the supplier.
